(19) United States
(12) Patent Application Publication
(10) Pub. No.: US 2010/0023922 A1
(43) Pub. Date: Jan. 28, 2010

(54) LINKING UML ACTIVITY DIAGRAM NODES TO UML CLASS DIAGRAM NODES BY USING PROPERTIES FROM APPLIED STEREOTYPES

(75) Inventors: Jonathan Limburn, Southampton (GB); Conor Peter Beverland, Southampton (GB); Iain Peter Duncan, Southampton (GB); Christopher Haragan, Bexhill (GB)

Correspondence Address: IBM CORPORATION (ACCSP);c/o Suiter Swantz pc llo, 14301 FNB Parkway, Suite 220, Omaha, NE, 68154, US

(73) Assignee: International Business Machines Corporation, Armonk, NY (US)

(21) Appl. No.: 12/178,155

(22) Filed: Jul. 23, 2008

(51) Int. Cl. G06F 9/44

(52) U.S. Cl. 717/104

(57) ABSTRACT

The present disclosure is directed to a method for associating an UML activity diagram with an UML class diagram. The method may comprise applying stereotypes to nodes in the UML activity diagram; specifying properties for the stereotypes, the properties may include information for linking nodes in activity diagram to role names in the class diagram; providing a mapping between nodes in the activity diagram and relationship objects in the class diagram based on the properties; and associating the activity diagram with the class diagram utilizing the mapping.

### TECHNICAL FIELD

The present disclosure generally relates to the field of computer science, and more particularly to Unified Modeling Language (UML).

### BACKGROUND

UML class diagrams typically show relationships between objects within a model, and UML activity diagrams typically show the flow of logic within a model. Existing techniques for linking class diagrams to activity diagrams includes embedding an activity diagram inside an object in a class diagram, or embedding the object in the class diagram inside the activity diagram, causing closely coupled models that may be cumbersome to maintain inside the current tooling.

### SUMMARY

The present disclosure is directed to a method for associating an UML activity diagram with an UML class diagram. The method may comprise applying stereotypes to nodes in the UML activity diagram; specifying properties for the stereotypes, the properties may include information for linking nodes in activity diagram to role names in the class diagram; providing a mapping between nodes in the activity diagram and relationship objects in the class diagram based on the properties; associating the activity diagram with the class diagram utilizing the mapping.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for associating an UML activity diagram with an UML class diagram.

### DETAILED DESCRIPTION

Reference will now be made in detail to the subject matter disclosed, which is illustrated in the accompanying drawings.

The present disclosure captures the use of a stereotype being applied to each activity node. A property on this applied stereotype may be set to the value of a corresponding role name on a class diagram that the activity node represents, thus providing a mapping between activity diagram nodes and class diagram objects. The present disclosure allows for looser coupling between the class and activity diagrams, ensuring that the concepts that are defined by each diagram are still maintained separately. A method to link non-class UML objects from the class diagram to the activity nodes may also be developed.

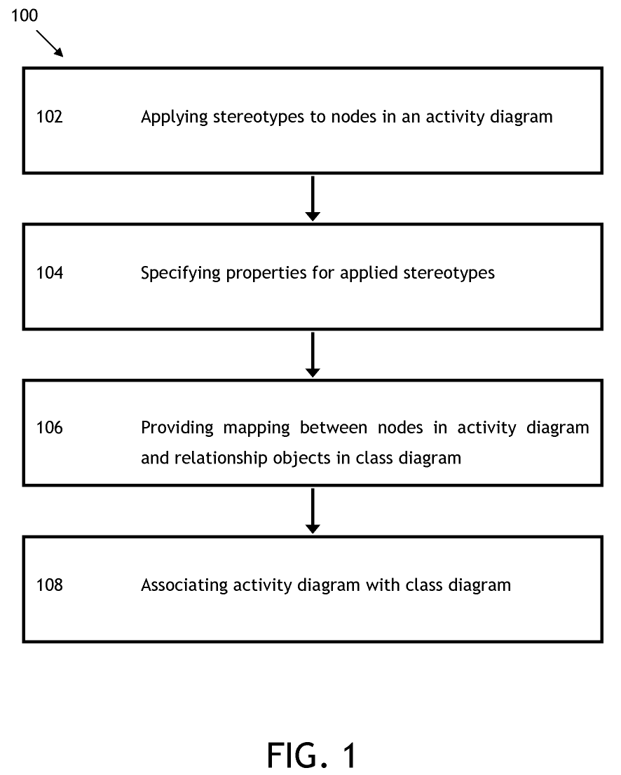

FIG. 1 shows a flow diagram illustrating steps performed by an association method 100 in accordance with the present disclosure. Step 102 applies a stereotype to at least one node in an activity diagram. Step 104 allows properties to be specified for each node that has a stereotype applied. Properties specified for a stereotype of a node may include information for linking the node to a role name in a class diagram. Based on the properties specified, step 106 provides a mapping between relationship objects in the class diagram and the nodes in the activity diagram. Step 108 utilizes the mapping to associate the activity diagram to the class diagram, providing a complete association between each object in the class diagram and all of the associated nodes in each activity diagram.

It is understood that by associating the relationship object in the class diagram to the nodes in the activity diagram, one may be able to extract information about the cardinality and relationship type as well as the data object that is being used, thus extending what was possible by using a simple UML object node. Utilizing the present disclosure, the relationship between class and activity diagrams may be loosely coupled in that changing one diagram has no impact on the other, and an association relationship is always maintained via the role name on the class diagram.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A computer program product for associating an UML activity diagram with an UML class diagram, comprising:
a tangible computer useable medium having computer useable code tangibly embodied therewith, the computer useable program code comprising:
computer useable program code configured to apply a stereotype to at least one node in said UML activity diagram;
computer useable program code configured to specify a property for said stereotype, wherein said property includes information for linking said at least one node in said UML activity diagram to at least one role name in said UML class diagram;
computer useable program code configured to provide a mapping between said at least one node in said UML activity diagram and at least one relationship object in said UML class diagram based on said property;
computer useable program code configured to associate said UML activity diagram with said UML class diagram utilizing said mapping; and
computer useable program code configured to extract an UML information, said UML information including at least one of a cardinality type, a relationship type, and a data object.
